(19) United States
(12) Patent Application Publication
(10) Pub. No.: US 2015/0177910 A1
(43) Pub. Date: Jun. 25, 2015

(54) COORDINATE DETECTION SYSTEM, COORDINATE DETECTION APPARATUS, AND COORDINATE DETECTION METHOD

(71) Applicant: Hiroshi SHIMURA, Kanagawa (JP)

(72) Inventor: Hiroshi SHIMURA, Kanagawa (JP)

(73) Assignee: RICOH COMPANY, LTD., Tokyo (JP)

(21) Appl. No.: 14/565,581

(22) Filed: Dec. 10, 2014

(30) Foreign Application Priority Data
Dec. 24, 2013 (JP) 2013-265973

(51) Int. Cl. G06F 3/042; G06F 3/041

(52) U.S. Cl. CPC G06F 3/0421; G06F 3/0414

(57) ABSTRACT

A coordinate-detection system for detecting coordinates pointed by a pointing device on a board face includes an image display to display an image, a first signal transmitter to output a first signal along the board face, a first signal receiver to receive the first signal output from the first signal transmitter, a first coordinate detector to detect coordinates pointed by the pointing device based on the received first signal, a signal requesting unit to transmit a third signal to the pointing device to request an output of a second signal from the pointing device when the first coordinate detector does not detect coordinates pointed by the pointing device, a second signal receiver to receive the second signal output from the pointing device, and a second coordinate detector to detect coordinates pointed by the pointing device based on the received second signal.

### CROSS-REFERENCE TO RELATED APPLICATION

This application claims priority pursuant to 35 U.S.C. §119(a) to Japanese Patent Application No. 2013-265973, filed on Dec. 24, 2013 in the Japan Patent Office, the disclosure of which are incorporated by reference herein in their entirety.

### BACKGROUND

1. Technical Field

The present invention relates to a coordinate detection system, a coordinate detection apparatus, and coordinate detection method for detecting an input on a display board.

2. Background Art

Electronic display systems configured with an electronic display board and an electronic pen used for inputting hand writing are available. To correctly display trajectory such as virtual line input by a hand writing operation on the electronic display board, position of the electronic pen is required to be identified with high precision. The position of the electronic pen can be identified based on blocking of light by the electronic pen (hereinafter, a light blocking image of the electronic pen).

However, when the positions of the electronic pen are identified based on the light blocking image, the position of the electronic pen may not be identified correctly if a user places a hand on the electronic display board. The position of the electronic pen can be identified by disposing a light emitting device in the electronic pen, but this configuration may increase power consumption of the electronic pen, and may require frequent power charging operations.

### SUMMARY

In one aspect of the present invention, a coordinate detection system for detecting coordinates pointed by a pointing device on a board face is devised. The coordinate detection system includes an image display to display an image, a first signal transmitter to output a first signal along the board face of the image display, a first signal receiver to receive the first signal output from the first signal transmitter, a first coordinate detector to detect coordinates pointed by the pointing device based on the first signal received by the first signal receiver, a signal requesting unit to transmit a third signal to the pointing device to request an output of a second signal from the pointing device when the first coordinate detector does not detect coordinates pointed by the pointing device based on the first signal received by the first signal receiver, a second signal receiver to receive the second signal output from the pointing device, and a second coordinate detector to detect coordinates pointed by the pointing device based on the second signal received by the second signal receiver.

In another aspect of the present invention, a coordinate detection apparatus for detecting coordinates pointed by a pointing device on a board face is devised. The coordinate detection apparatus includes an image display to display an image, a first signal transmitter to output a first signal along the board face of the image display, a first signal receiver to receive the first signal output from the first signal transmitter, a first coordinate detector to detect coordinates pointed by the pointing device based on the first signal received by the first signal receiver, a signal requesting unit to transmit a third signal to the pointing device to request an output of a second signal from the pointing device when the first coordinate detector does not detect coordinates pointed by the pointing device based on the first signal received by the first signal receiver, a second signal receiver to receive the second signal output from the pointing device, and a second coordinate detector to detect coordinates pointed by the pointing device based on the second signal received by the second signal receiver.

In another aspect of the present invention, a coordinate detection method for detecting coordinates pointed by a pointing operation of a pointing device on a board face is devised. The method includes the steps of outputting a first signal along a board face of the image display (first signal outputting step), receiving the first signal output by the first signal transmitting step (first signal receiving step), detecting coordinates pointed by the pointing device based on the first signal received at the first signal receiving step (first coordinate detecting step), transmitting a third signal to the pointing device to request an output of a second signal from the pointing device when the first coordinates detecting step does not detect coordinates pointed by the pointing device based on the received first signal (request transmitting step), receiving the second signal output from the pointing device (second signal receiving step); and detecting coordinates pointed by the pointing device based on the second signal received by the second signal receiving step (second coordinate detecting step).

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram of functional configuration of a coordinate detection system according to one or more example embodiments;

FIG. 2 is a block diagram of hardware configuration of the coordinate detection system according to an example one or more example embodiments;

FIGS. 3A and 3B are a flow chart showing the steps of process of light-emission control based on a timer;

FIGS. 4A and 4B are a flow chart showing the steps of process of light-emission control based on a request of light emission or a request of light-off;

FIGS. 5A and 5B are a flow chart showing the steps of process of light-emission control based on pressure detection;

FIG. 6 is a schematic view an electronic display board having a signal transmitter and a signal receiver, and a detection area;

FIG. 7 is a schematic view of an electronic pointing device having a signal transmitter at a front end;

FIGS. 8A and 8B are profiles of detection signals when no light blocking object exists in a detection area of a light blocking object detection area;

FIG. 9 is a schematic view an electronic display board and an electronic pointing device;

FIGS. 10A and 10B are profiles of detection signals when light is blocked by an electronic pointing device;

FIG. 11 is a schematic view an electronic display board, an electronic pointing device, and a hand placed on the electronic display board;

FIGS. 12A and 12B are profiles of detection signals when light is blocked by an electronic pointing device and a hand placed on the electronic display board; and

FIGS. 13A and 13B are profiles of detection signals when light is blocked by an electronic pointing device and a hand placed on the electronic display board and when the electronic pointing device emits light.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of one or more exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, an apparatus or system according to one or more example embodiments is described hereinafter.

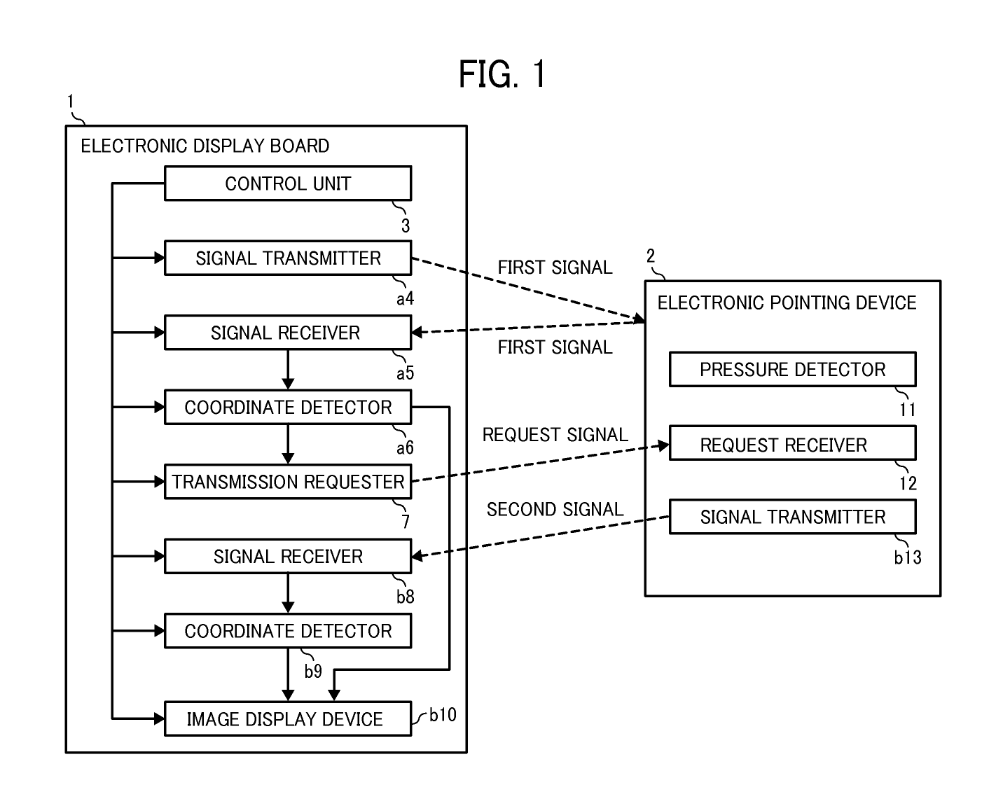

FIG. 1 is a block diagram of functional configuration of a coordinate detection system according to one or more example embodiments. The coordinate detection system can be configured with an electronic display board 1, and an electronic pointing device 2. The electronic display board 1 includes, for example, a control unit 3, a signal transmitter a4 (useable as a first signal transmitter), a signal receiver a5 (useable as a first signal receiver), a coordinate detector a6 (useable as a first coordinate detector), a transmission requester 7 (useable as a signal requesting unit), a signal receiver b8 (useable as a second signal receiver), a coordinate detector b9 (useable as a second coordinate detector), and an image display device 10 (useable as an image display).

The electronic pointing device 2, which is also an electronic writing device, is a pointing device used for conducting a pointing operation to a board surface of the electronic display board 1. The electronic pointing device 2 includes, for example, a pressure detector 11, a request receiver 12, and a signal transmitter b13. The electronic pointing device 2 is known, for example, as an electronic pen or the like.

The signal transmitter a4, useable as the first signal transmitter, outputs a first signal such as infrared ray. The signal receiver a5, useable as the first signal receiver, receives the first signal output from the signal transmitter a4 as shown in FIG. 1.

The coordinate detector a6, useable as the first coordinate signal detector, detects coordinates of the electronic pointing device 2 based on the first signal received by the signal receiver a5 to identify a position of the electronic pointing device 2.

The transmission requester 7, useable as the signal requesting unit, requests the electronic pointing device 2 to output a second signal such as infrared ray from the electronic pointing device 2 by transmitting a light-emission request as a third signal to the electronic pointing device 2.

The request receiver 12 of the electronic pointing device 2 receives the light-emission request of the second signal from the electronic display board 1. The signal transmitter b13 of the electronic pointing device 2 outputs the second signal. The signal receiver b8 of the electronic display board 1, useable as the second signal receiver, receives the second signal output from the signal transmitter b13 as shown in FIG. 1.

For example, the first and second signals can employ electromagnetic wave of infrared range. When the first and second signals use the electromagnetic wave of infrared range for identifying positions, diffraction effect can be reduced, with which position can be identified precisely, and when the electromagnetic wave of infrared range is used, the first and second signals are not visible to eyes of a user.

Further, if the wavelength range of the second signal is set same as the wavelength range of the first signal range such as the electromagnetic wave of infrared range, the signal receiver b8 can be substituted by the signal receiver a5. By setting the same wavelength for the first signal and the second signal, the signal receiver a5 and the signal receiver b8 can be configured as one signal receiver.

The coordinate detector b9, useable as the second coordinate detector, identifies position of the electronic pointing device 2 based on the second signal received by the signal receiver b8, useable as the second receiver.

The image display device 10, used as the image display, displays an image on a board face such as a display face of the image display device 10. Handwriting image such as handwriting text can be drawn on the display face of the image display device 10 at an area pointed by the electronic pointing device 2.

When the coordinate detector a6 (i.e., first coordinate detector) cannot identify the position of the electronic pointing device 2, the control unit 3 transmits a light-emission request to the electronic pointing device 2 so that position identification of the electronic pointing device 2 can be conducted by the coordinate detector b9 (i.e. second coordinate detector). The pressure detector 11 detects whether the electronic pointing device 2 is pressed to the image display device 10.

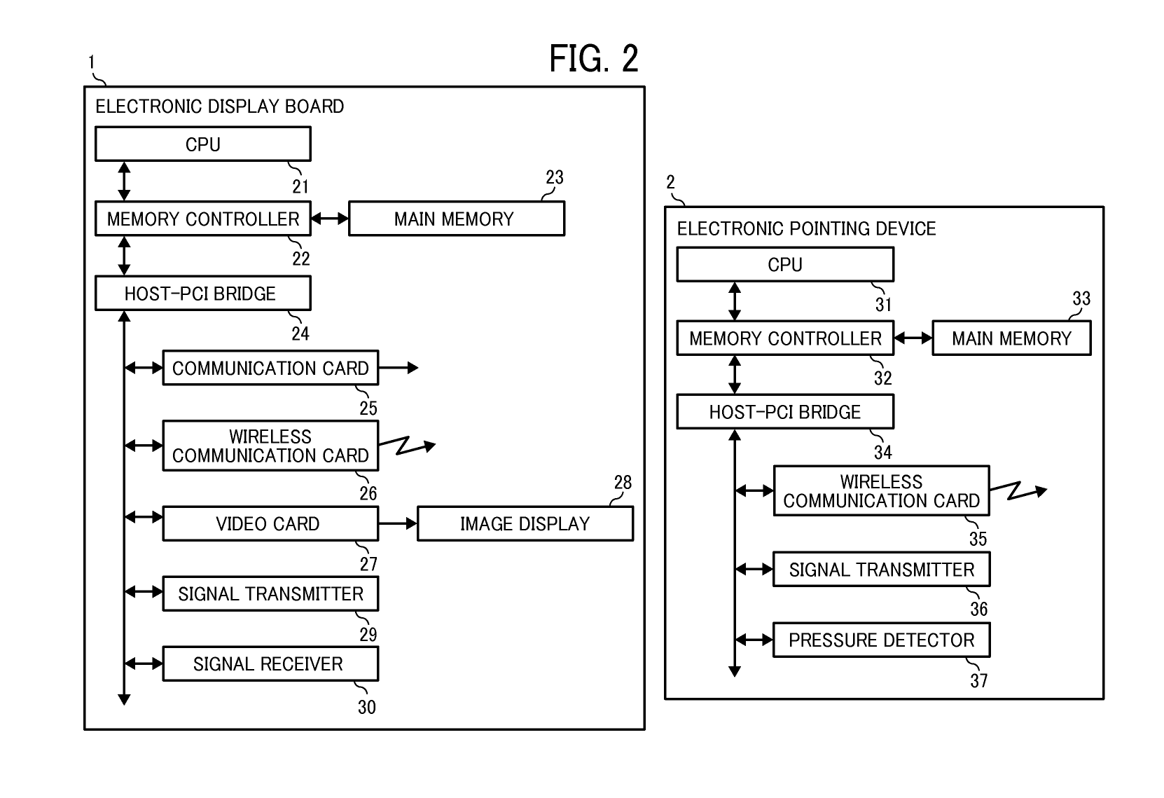

FIG. 2 is a block diagram of a hardware configuration of the coordinate detection system according to one or more example embodiments. The electronic display board 1 includes, for example, a central processing unit (CPU) 21, a memory controller 22, a main memory 23, a host-peripheral component interconnect (PCI) bridge 24, a communication card 25, a wireless communication card 26, a video card 27, an image display 28, a signal transmitter 29, and a signal receiver 30. The signal transmitter 29 of the electronic display board 1 can be used as the signal transmitter 4 (i.e., first signal transmitter), and the transmission requester 7 (i.e., signal requesting unit) shown in FIG. 1.

The electronic pointing device 2 includes, for example, a central processing unit (CPU) 31, a memory controller 32, a main memory 33, a host-PCI bridge 34, a wireless communication card 35, a signal transmitter 36, and a pressure detector 37.

The CPU 21 of the electronic display board 1 analyses a signal received by the signal receiver 30 to identify a position of the electronic pointing device 2. Position of the electronic pointing device 2 can be identified by a first method using the first signal, and a second method using the second signal.

The CPU 21 of the electronic display board 1 can be used as the first coordinate detector that detects coordinates pointed by the electronic pointing device 2 based on the first signal received by the signal receiver 30, in which the signal receiver 30 can be used as the first signal receiver that receives the first signal. Further, the CPU 21 of the electronic display board 1 can be used as the second coordinate detector that detects coordinates pointed by the electronic pointing device 2 based on the second signal received by the signal receiver 30, in which the signal receiver 30 can be used as the second signal receiver that receives the second signal.

The communication card 25 is used for wireless communication between the electronic display board 1 and the electronic pointing device 2. The electronic display board 1 can transmit a light-emission request to the electronic pointing device 2, in which communication can be conducted using, for example, infrared ray. The signal transmitter 36 of the electronic pointing device 2 outputs the second signal.

The signal receiver 30 receives the first signal and the second signal. When the first and second signals employ signals having totally different wavelength ranges, the signal receiver 30 is disposed for each one of the first signal and the second signal. The pressure detector 37 detects whether the electronic pointing device 2 is pressed to the image display 28.

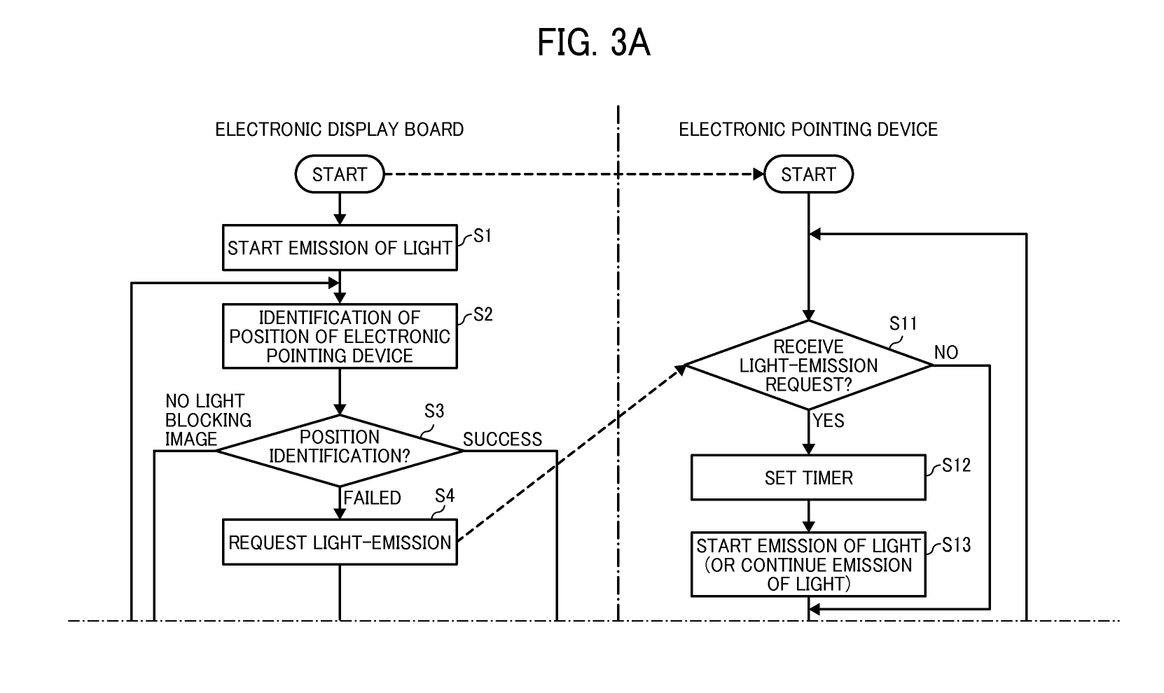

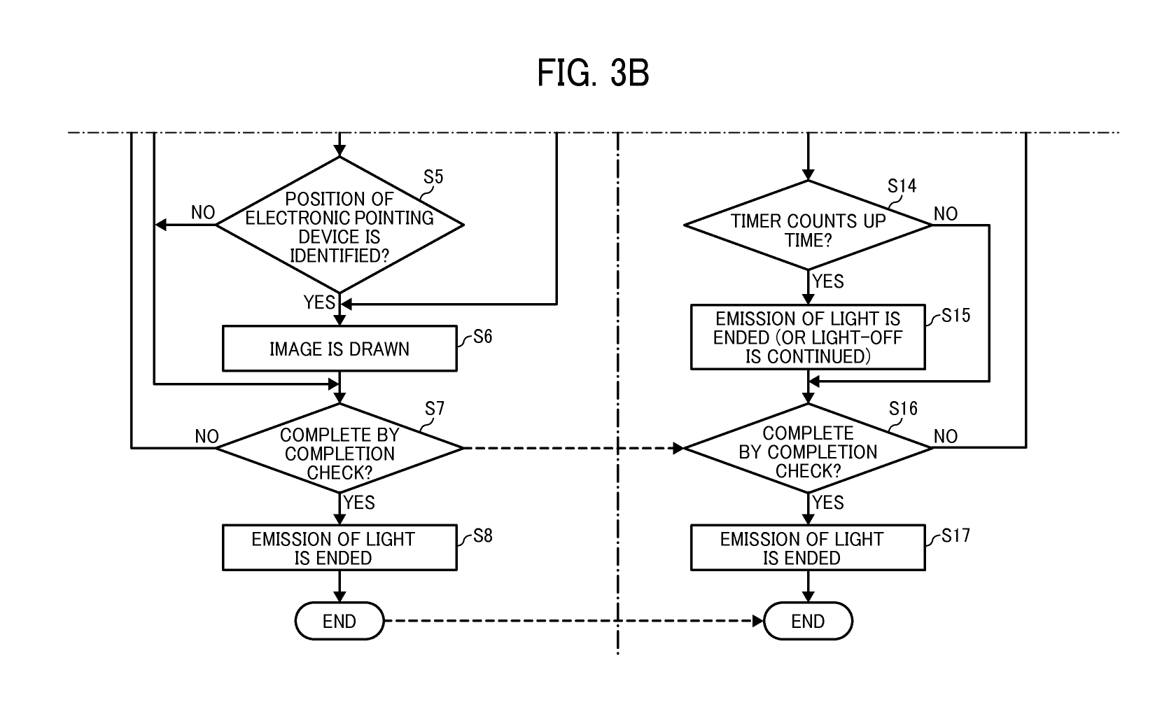

FIGS. 3A and 3B are a flow chart showing the steps of process of light-emission control based on a timer, in which light emission of the electronic pointing device 2 can be stopped by using a timer disposed for the electronic pointing device 2. The electronic display board 1 starts emission of light such as infrared ray to start an output of the first signal (step S1). Emitted infrared ray is received by the signal receiver 30, and a position of the electronic pointing device 2 is identified based on a light blocking image of the electronic pointing device 2 (step S2).

In this configuration, when the position of the electronic pointing device 2 is identified, it is determined success, when the position of the electronic pointing device 2 cannot be identified, it is determined failure, and when no light blocking images is detected, the process proceeds to step S7 without the light blocking image (step S3).

When the position identification is conducted successfully (S3: success), an image is drawn based on the obtained position information of the electronic pointing device 2 (step S6). When no light blocking images is detected (S3: no light blocking image), a completion check is conducted (step S7).

The completion check means a check process to determine whether a completion process is instructed. A display screen of the electronic display board 1 can display various icons with a given arrangement pattern. By pointing an icon using the electronic pointing device 2, a function corresponding to the pointed icon can be called. A completion process icon is one of these icons. The completion process is conducted when the completion process icon is touched by the electronic pointing device 2.

When the position identification is failed (S3: failed), the electronic display board 1 transmits a light-emission request as a third signal to the electronic pointing device 2 to emit the second signal such as infrared ray from the electronic pointing device 2 (step S4). The infrared ray emitted from the electronic pointing device 2 is received by the signal receiver 30 of the electronic display board 1 to identify a position of the electronic pointing device 2 (step S5).

When the position of the electronic pointing device 2 is identified (step S5: Yes), an image is drawn based on the obtained position information of the electronic pointing device 2 (step S6). When the position of the electronic pointing device 2 is not identified (step S5: No), the completion check is conducted (step S7).

When the process completes by conducting the completion check (step S7: Yes), emission of infrared ray is stopped (step S8). If the process still continues after conducting the completion check (step S7: No), emitted infrared ray is received by the signal receiver 30, and a position of the electronic pointing device 2 is identified based on a light blocking image (step S2) of the electronic pointing device 2.

The electronic pointing device 2 checks whether a light-emission request transmitted at step S4 is received (step S11), and proceeds the process based on a result at step S11. When the light-emission request is not received by the electronic pointing device 2 (step S11: No), the electronic pointing device 2 checks whether a given time period elapses, in which a timer counts the given time period (step S14).

When the light-emission request is received by the electronic pointing device 2 (step S11: Yes), the timer is set (step S12). For example, the timer is set to five seconds, and further, if the timer is already set, a time period is set again to the timer. Then, the emission of infrared ray is started, and if the infrared ray is already being emitted, the emission of infrared ray is continued (step S13), with which an output of the second signal starts.

Then, it is checked whether the timer counts the given time period (step S14), which is referred to as timer completion. The timer completion means that the time period set at step S12 elapses. If the timer still continues to count (step S14: No), the completion check is conducted (step S16).

When the timer counts the given time period (step S14: Yes), emission of the infrared ray is ended. If the infrared ray is not emitted, light-off condition is continued (step S15), and then the completion check is conducted (step S16).

When the process ends (step S16: Yes), emission of the infrared ray is also ended (step S17). When the process still continues (step S16: No), it is checked whether a light-emission request is transmitted at step S4 and received by the electronic pointing device 2 at step S11.

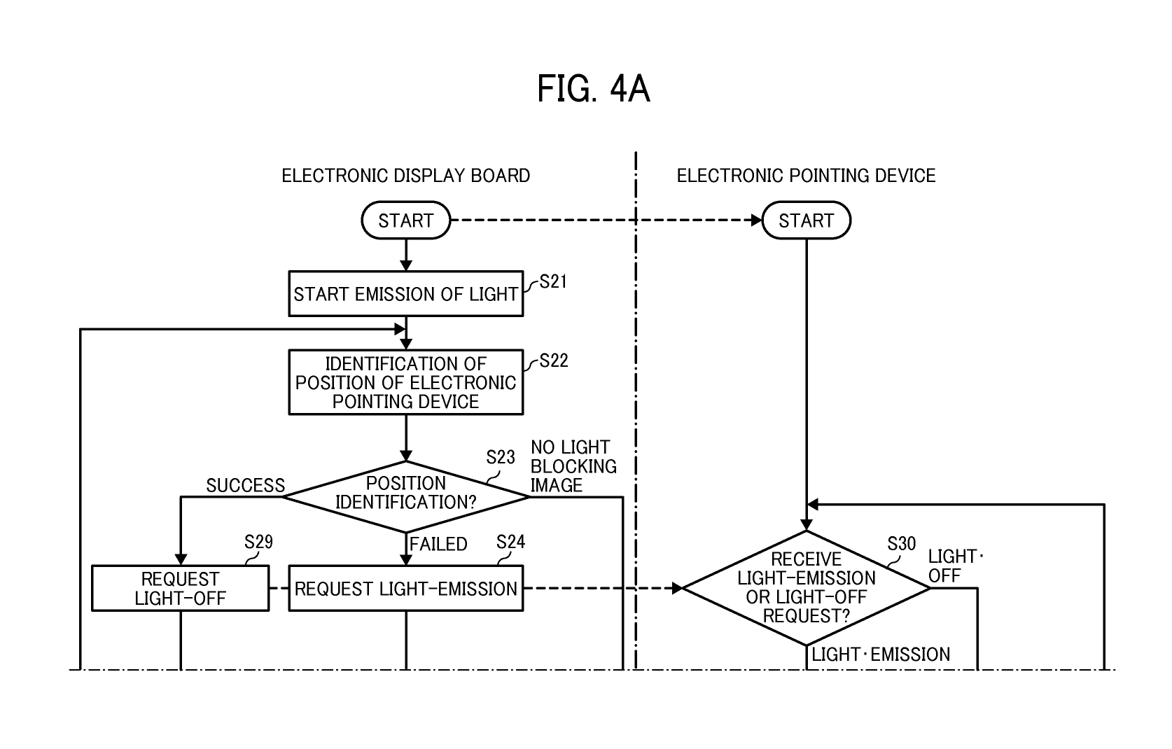

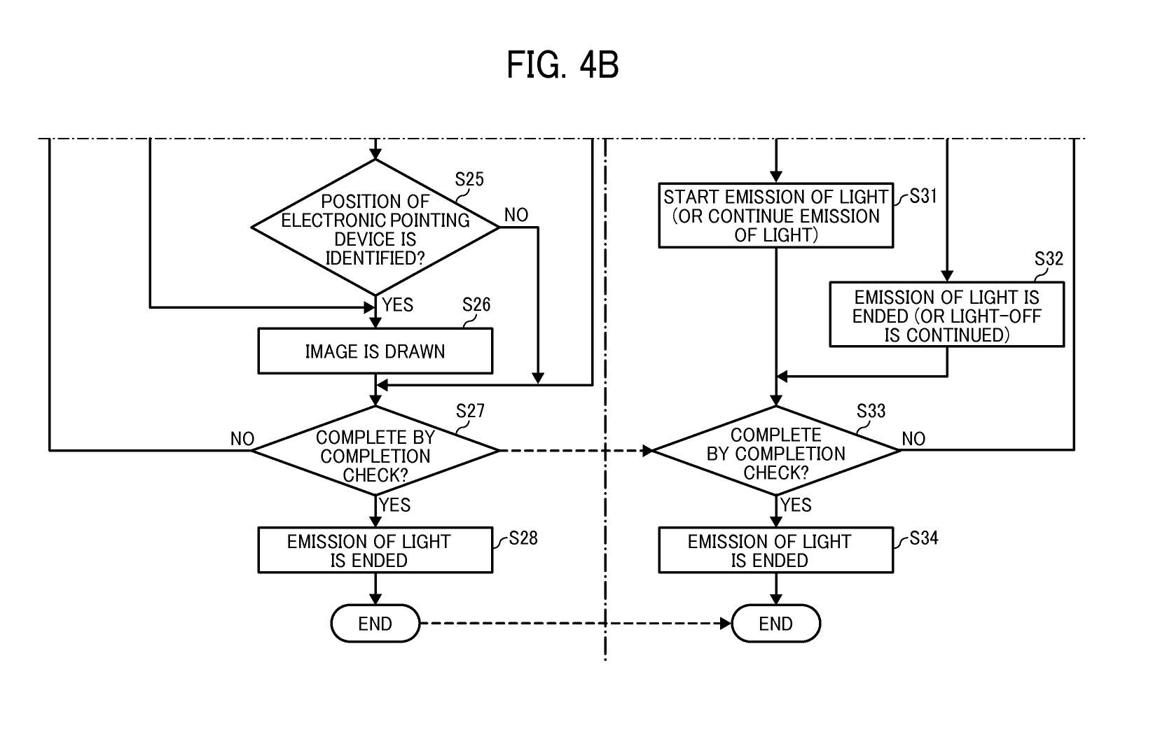

FIGS. 4A and 4B are a flow chart showing the steps of process of light-emission control based on a request of light emission or a request of light-off. In this process, stop of emission of light from the electronic pointing device 2 is requested by the electronic display board 1 to the electronic pointing device 2.

Emission of the infrared ray is started (step S21) to start an output of the first signal. The emitted infrared ray is received by the signal receiver 30, and a position of the electronic pointing device 2 is identified based on a light blocking image (step S22) generated by the electronic pointing device 2.

In this configuration, when the position of the electronic pointing device 2 is identified successfully, it is determined success, when the position of the electronic pointing device 2 cannot be identified, it is determined failure, and when no light blocking images is detected, the process proceeds to step S27 without a light blocking image (step S23).

When the position identification is successfully conducted, a light-off request is transmitted to the electronic pointing device 2 (step S29), and an image is drawn based on the obtained position information of the electronic pointing device 2 (step S26). When no light blocking images is detected, the completion check is conducted (step S27).

When the position identification is failed, the electronic display board 1 transmits a light-emission request to the electronic pointing device 2 to request an emission of the second signal such as infrared ray from the electronic pointing device 2 (step S24). The infrared ray emitted from the electronic pointing device 2 is received by the signal receiver 30 to identify a position of the electronic pointing device 2 based on the received light signal (step S25).

When the position is identified (step S25: Yes), an image is drawn based on the obtained position information of the electronic pointing device 2 (step S26). When the position is not identified (step S25: No), the completion check is conducted (step S27).

When the process ends by conducting the completion check (step S27: Yes), emission of the infrared ray is stopped (step S28). When the process still continues after conducting the completion check (step S27: No), the emitted infrared ray is received by the signal receiver 30, and a position of the electronic pointing device 2 is identified based on a light blocking image (step S22) of the electronic pointing device 2.

The electronic pointing device 2 checks whether a light-emission request transmitted at step S24 or a light-off request transmitted at step S29 is received (step S30), and then proceeds the process based on a check result at step S30. When the light-emission request is received by the electronic pointing device 2 (step S30), emission of the infrared ray is started, and if the light is already emitted, emission of the infrared ray is continued (step S31).

When the light-off request is received by the electronic pointing device 2 (step S30), emission of the infrared ray is ended, and if the infrared ray is not emitted, light-off condition is continued (step S32). The electronic display board 1 includes the transmission requester 7 that transmits a fourth signal as a signal requesting the electronic pointing device 2 to stop an output of the second signal from the electronic pointing device 2. With this configuration, an output of the second signal from the electronic pointing device 2 can be stopped immediately, and power saving performance can be enhanced.

Then, the completion check is conducted (step S33). When the process ends (step S33: Yes), emission of the infrared ray also ends (step S34). When the process still continues (step S33: No), it is checked whether a light-emission request at step S24 or a light-off request at S29 is received by the electronic pointing device 2 (step S30).

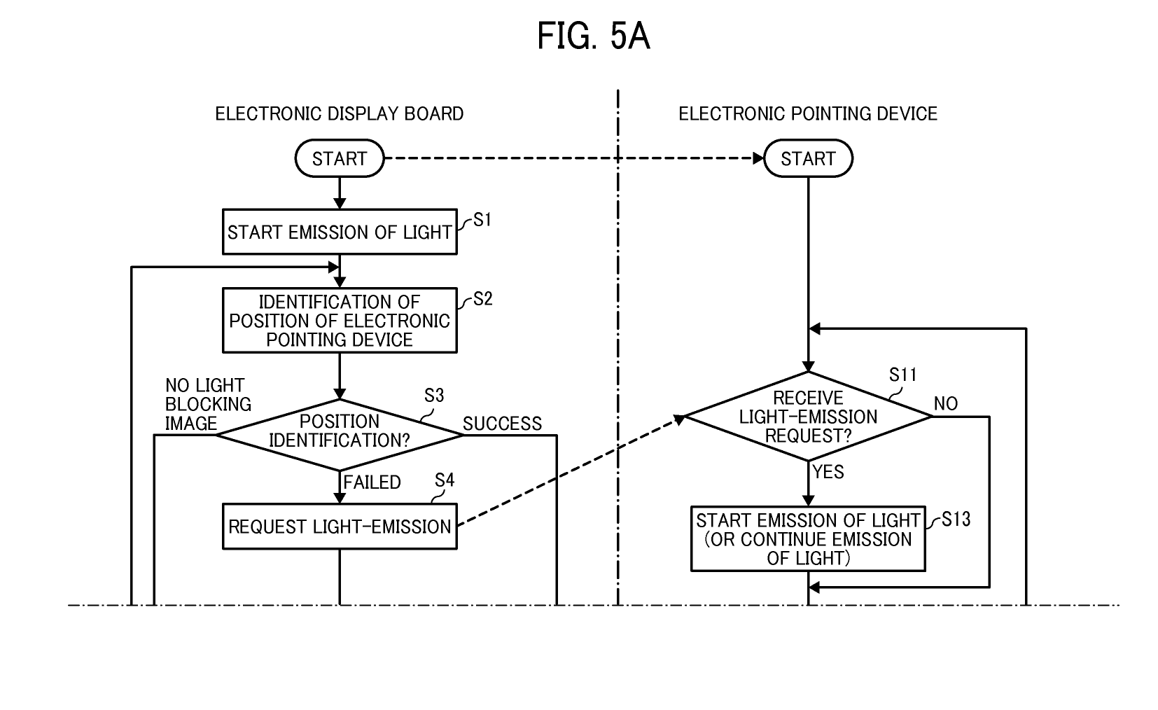

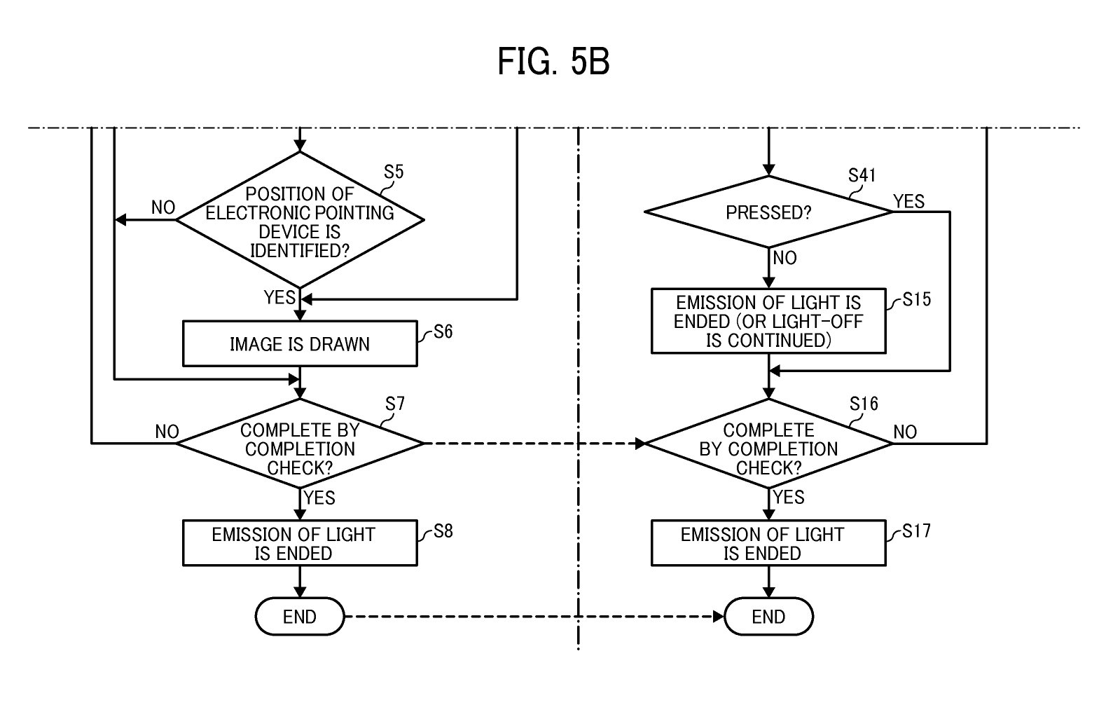

FIGS. 5A and 5B are a flow chart showing the steps of process of light-emission control based on pressure detection. In this process, stop of emission of light from the electronic pointing device 2 can be conducted by detecting pressure of the electronic pointing device 2. The steps of process same as the steps of process of FIGS. 3A and 3B are attached with the same references, and thereby the explanation of these same steps is omitted.

The electronic pointing device 2 checks whether a light-emission request transmitted at step S4 is received (step S11), and proceeds the process based on a result at step S11. When the light-emission request is received by the electronic pointing device 2 (step S11: Yes), emission of the infrared ray is started, and if the infrared ray is already being emitted, the emission of infrared ray is continued (step S13) to start an output of the second signal (i.e., infrared ray).

Then, it is determined whether a front end of the electronic pointing device 2 is pressed (step S41), and the process proceeds based on a result at step 41.

When the light-emission request is not received by the electronic pointing device 2 (step S11: No), it is checked whether the front end of the electronic pointing device 2 is pressed (step S41).

When the front end of electronic pointing device 2 is not pressed (step S41: No), emission of the infrared ray is ended, and if the infrared ray is not emitted, light-off condition is continued (step S15). Then, the completion check is conducted (step S16).

The electronic pointing device 2 includes the pressure detector 11 that can detect pressure applied to the electronic display board 1. When the pressure detector 11 does not detect pressure, the control unit 3 of the electronic display board 1 transmits the fourth signal as a signal requesting the electronic pointing device 2 to stop an output of the second signal from the electronic pointing device 2. With this configuration, when the electronic pointing device 2 ends a pointing operation (e.g., writing operation) to the electronic display board 1, an output of the second signal can be stopped immediately, with which power saving performance can be enhanced.

When the front end of the electronic pointing device 2 is pressed (step S41: Yes), the completion check is conducted (step S15). When the process ends (step S16: Yes), emission of the second signal (i.e., infrared ray) also ends (step S17). When the process still continues (step S16: No), it is checked whether a light-emission request at step S4 is received by the electronic pointing device 2 (step S11).

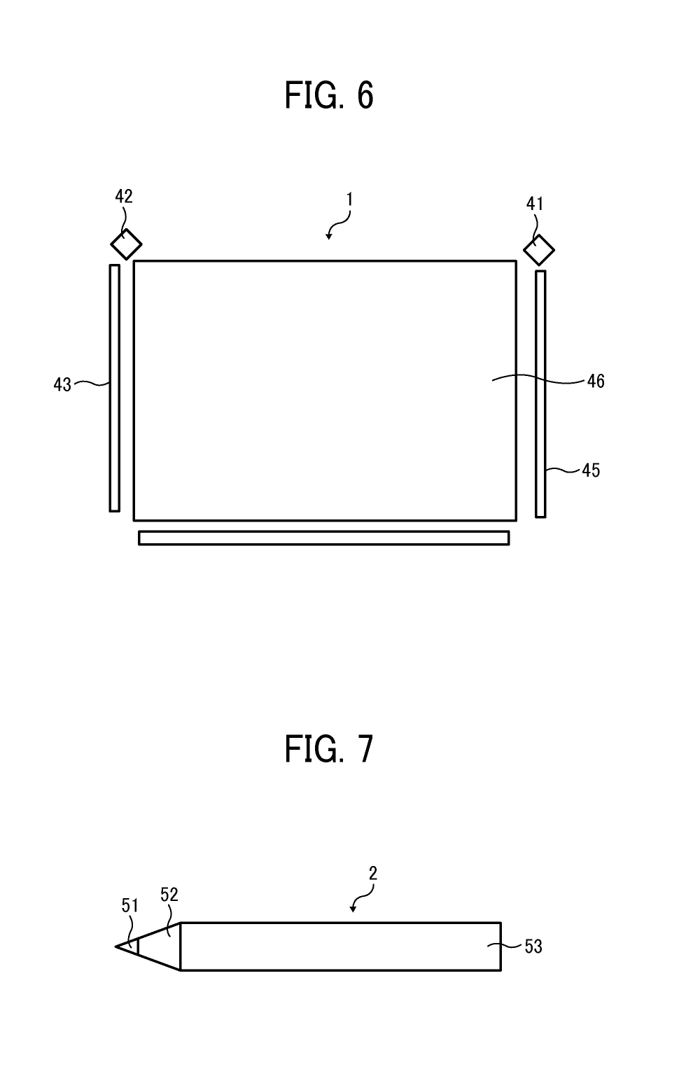

FIG. 6 is a schematic view of the electronic display board 1 having the signal receivers 41 and 42, the signal transmitters 43 to 45 (i.e., first signal transmitter), and a detection area 46, wherein the signal receiver 41 can be used as the first signal receiver and second signal receiver, and the signal receiver can be used as the first signal receiver and second signal receiver. For example, the electronic display board 1 can be applied as an electronic white board, in which the detection area 46 is matched to a display area of a display that displays data output from a computer.

The signal receivers 41 and 42 are disposed at each of upper corners of the detection area 46, but an arrangement of the signal receivers is not limited hereto. The number of signal receivers can be increased or decreased depending on the pointing device and the number of fingers to be detected in the detection area 46.

Each of the signal transmitters 43 to 45 employs a bar-shaped light emitter disposed around the detection area 46 as illustrated in FIG. 6, and light is emitted from the entire of the signal transmitters 43 to 45. Each of the signal receivers 41 and 42 is disposed at a position that can view two sides at a counter direction from the position of the signal receivers 41 and 42. For example, the signal receiver 41 is disposed at a position that can receive light from the signal transmitters 43 and 44, and the signal receiver 42 is disposed at a position that can receive light from the signal transmitters 44 and 45.

Each of the signal receivers 41 and 42 can be configured with a one-dimensional or two-dimensional sensor, and an imaging forming optical system. Information or data of the signal receivers 41 and 42 is processed by a processor such as a computer, and an intensity profile output from the signal receivers 41 and 42 is used to compute positions pointed on the detection area 46.

Because the coordinates are detected when light emitted from the signal transmitters 43 to 45 is blocked by an object, it is preferable to emit light uniformly as much as possible, in which a light guide plate used for a signage can be employed. Further, the light guide plate is made of material such as acrylic resin having higher transparency, which can enhance efficiency of light use.

FIG. 7 is a schematic view of the electronic pointing device 2 having a signal transmitter 51 disposed at a front end of the electronic pointing device 2, in which wavelength of light emitted from the signal transmitter 51 is matched to wavelength of light detectable by the signal receiver, and the light emitted from the signal transmitter 51 employs, for example, visible light or infrared light.

The electronic pointing device 2 includes a moveable part 52 integrated with the signal transmitter 51, which outputs the second signal, disposed at the front end of the electronic pointing device 2.

When pressure is applied to the signal transmitter 51 disposed at the front end during a pointing operation (e.g., writing operation) by the electronic pointing device 2, the moveable part 52 moves toward a holding unit 53 with the signal transmitter 51 disposed at the front end. When the moveable part 52 is made of material that does not expand and shrink, a gap or space, matched to a movement amount, is set between the holding unit 53 and the moveable part 52 so that the moveable part 52 can be moved in the gap or space.

Further, the moveable part 52 can be made of material such as rubber that expands and shrinks, in which a gap or space is not set between the holding unit 53 and the moveable part 52. In this configuration, a sensor to detect pressure is disposed in the moveable part 52 to detect pressure. The signal transmitter 51 disposed at the front end is turned off (i.e., light-off) when pressure is not detected, with which power consumption of the electronic pointing device 2 can be reduced when no image is drawn.

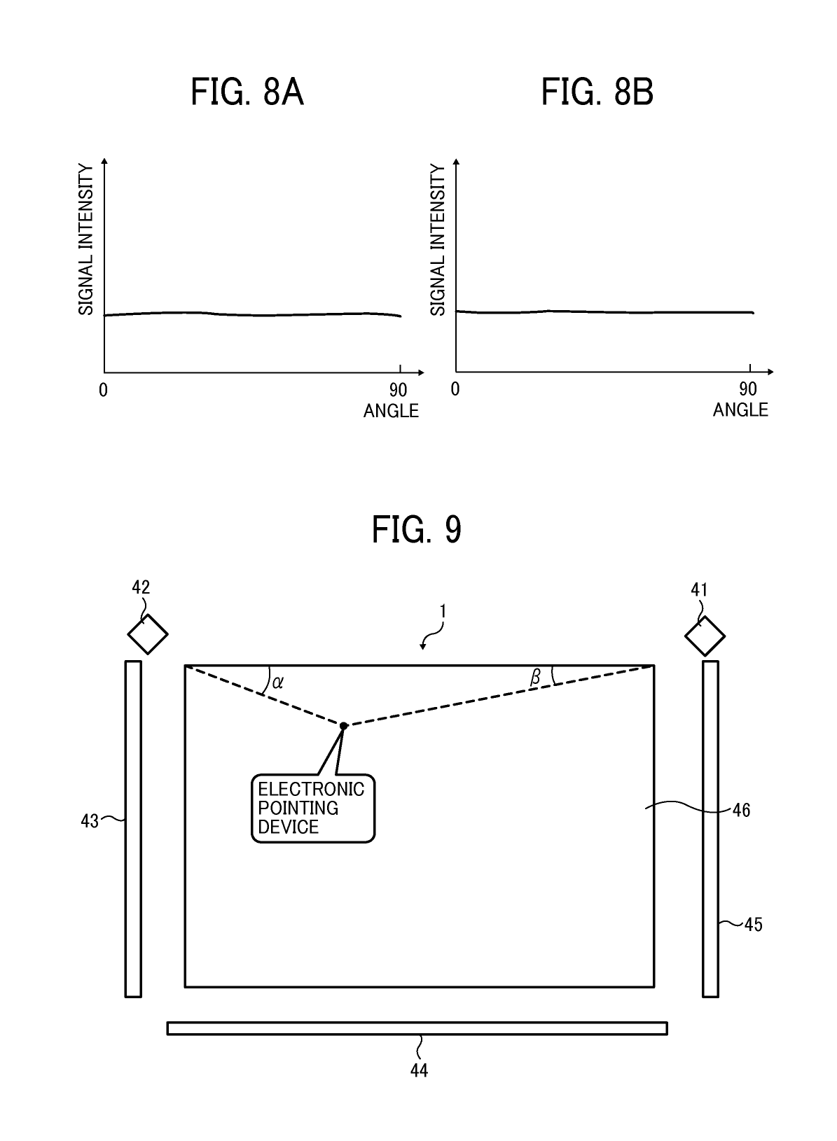

A description is given of detection signals of the signal receivers 41 and 42. FIG. 8 is a case when no light blocking object exists in the detection area 46. FIG. 8A is a detection signal profile of the signal receiver 41, and FIG. 8B is a detection signal profile of the signal receiver 42. The horizontal axis indicates angle, and the vertical axis indicates signal intensity. Light intensity received by the signal receiver varies depending on angle, but the light intensity is corrected so that light intensity received by the signal receiver can be set at uniform intensity for the entire range of angle.

FIG. 9 illustrates an example case when the electronic pointing device 2 is on the electronic display board 1. A position of the electronic pointing device 2 can be defined based on angle β for the signal receiver 41, and angle α for the signal receiver 42.

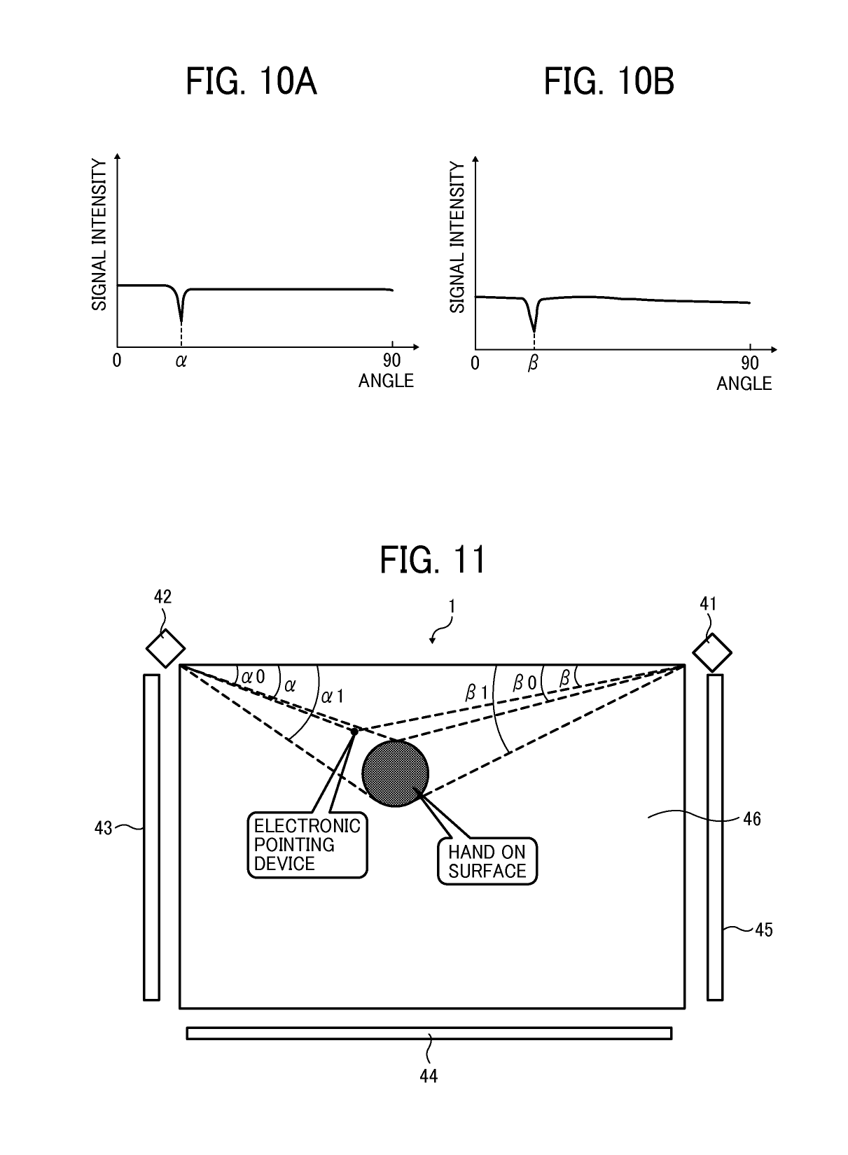

FIG. 10 shows detection signals when light is blocked by the electronic pointing device 2 as illustrated in FIG. 9. FIG. 10A is a detection signal profile of the signal receiver 41, and FIG. 10B is a detection signal profile of the signal receiver 42. The detection signal profile of the signal receiver 41 has a negative peak at angle α. The detection signal profile of the signal receiver 42 has a negative peak at angle 13. The coordinate detector a6 estimates a position of the electronic pointing device 2 based on the angles for the negative peaks, in which a position that intersects two lines extending from the signal receiver 41 and the signal receiver 42 can be detected as a position of the electronic pointing device 2.

FIG. 11 illustrates an example case when the electronic pointing device 2 is on the electronic display board 1 while a hand is placed on the electronic display board 1. A position of the electronic pointing device 2 can be defined based on angle β for the signal receiver 41, and angle α for the signal receiver 42 while a position of the hand placed on the electronic display board 1 can be defined based on angle β0 to β1 for the signal receiver 41, and angle α0 to α1 for the signal receiver 42.

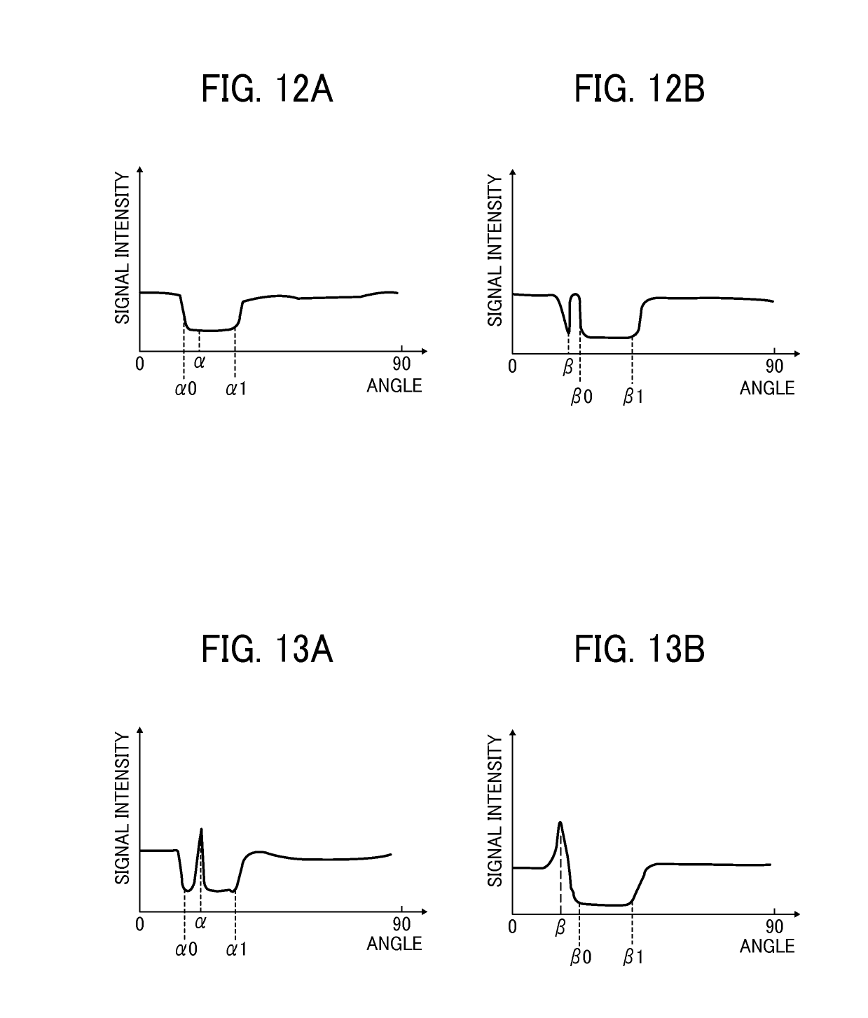

FIG. 12 shows detection signals when light is blocked by the electronic pointing device 2 and the hand placed on the electronic display board 1 as illustrated in FIG. 11. FIG. 12A is a detection signal profile of the signal receiver 41, and FIG. 12B is a detection signal profile of the signal receiver 42. The detection signal profile of the signal receiver 41 has a negative range from angle α0 to α1 without a negative peak. Therefore, the coordinate detector a6 can detect that something exists as a light blocking object, but cannot estimate a position of the electronic pointing device 2 correctly.

FIG. 13 shows detection signals when light is blocked by the electronic pointing device 2 and the hand placed on the electronic display board 1 as illustrated in [symbol] 11, and the electronic pointing device 2 emits light. FIG. 13A is a detection signal profile of the signal receiver 41, and FIG. 13B is a detection signal profile of the signal receiver 42. The detection signal profile of the signal receiver 41 has a positive peak at angle α. The detection signal profile of the signal receiver 42 has a positive peak at angle β. Based on the angles corresponding to the positive peaks, the coordinate detector b9 estimates a position that intersects a line extending from the signal receiver 41 and a line extending from the signal receiver 42 as a position of the electronic pointing device 2.

When the electronic pointing device 2 does not emit light, angles corresponding to negative peaks are detected, and a position that intersects the lines extending from the signal receiver 41 and the signal receiver 42 is identified as a position of the electronic pointing device 2

By contrast, when the electronic pointing device 2 emits light, angles corresponding to positive peaks are detected, and a position that intersects the lines extending from the signal receiver 41 and the signal receiver 42 is identified as a position of the electronic pointing device 2

In the above described configuration, precision of position detection of the electronic pointing device can be enhanced while reducing power consumption of the electronic pointing device.

When a position of the electronic pointing device is identified based on a light blocking image alone, power consumption of the electronic pointing device can be same as conventional configuration.

When a position of the electronic pointing device cannot be identified based on a light blocking image due to a hand or the like placed on a board, the electronic pointing device emits light, and the light emission direction of the electronic pointing device is detected, with which the position of the electronic pointing device can be identified, and detection precision can be enhanced

Further, because a hand is not placed on a board usually, light emission time of the electronic pointing device can be a short time, and thereby power consumption of the electronic pointing device can be reduced.

As to the above described optical coordinate input device such as the electronic pointing device, detection precision of position of the electronic writing device can be enhanced while reducing power consumption of the electronic pointing device.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. A coordinate detection system for detecting coordinates pointed by a pointing device on a board face, comprising:
an image display to display an image;
a first signal transmitter to output a first signal along the board face of the image display;
a first signal receiver to receive the first signal output from the first signal transmitter;
a first coordinate detector to detect coordinates pointed by the pointing device based on the first signal received by the first signal receiver;
a signal requesting unit to transmit a third signal to the pointing device to request an output of a second signal from the pointing device when the first coordinate detector does not detect coordinates pointed by the pointing device based on the first signal received by the first signal receiver;
a second signal receiver to receive the second signal output from the pointing device; and
a second coordinate detector to detect coordinates pointed by the pointing device based on the second signal received by the second signal receiver.

2. The coordinate detection system of claim 1, wherein the signal requesting unit transmits a fourth signal to the pointing device to request the pointing device to stop an output of the second signal when coordinates pointed by the pointing device is detected by the first coordinate detector.

3. The coordinate detection system of claim 1, wherein the pointing device includes a pressure detector that detects pressure applied to the image display, wherein the signal requesting unit transmits a fourth signal to the pointing device to request the pointing device to stop an output of the second signal when the pressure detector does not detect pressure.

4. The coordinate detection system of claim 1, wherein the first signal and the second signal are electromagnetic wave of infrared range.

5. The coordinate detection system of claim 1, wherein the first signal and the second signal are electromagnetic wave of infrared range having the same wavelength.

6. A coordinate detection apparatus for detecting coordinates pointed by a pointing operation of a pointing device on a board face, comprising:
an image display to display an image;
a first signal transmitter to output a first signal along a board face of the image display;
a first signal receiver to receive the first signal output from the first signal transmitter;
a first coordinate detector to detect coordinates pointed by the pointing device based on the first signal received by the first signal receiver;
a signal requesting unit to transmit a third signal to the pointing device to request an output of a second signal from the pointing device when the first coordinate detector does not detect coordinates pointed by the pointing device based on the first signal received by the first signal receiver;
a second signal receiver to receive the second signal output from the pointing device; and
a second coordinate detector to detect coordinates pointed by the pointing device based on the second signal received by the second signal receiver.

7. The coordinate detection apparatus of claim 6, wherein the signal requesting unit transmits a fourth signal to the pointing device to request the pointing device to stop an output of the second signal when coordinates pointed by the pointing device is detected by the first coordinate detector.

8. The coordinate detection apparatus of claim 6, wherein the pointing device includes a pressure detector that detects pressure applied to the image display,
wherein the signal requesting unit transmits a fourth signal to the pointing device to request the pointing device to stop an output of the second signal when the pressure detector does not detect pressure.

9. The coordinate detection apparatus of claim 6, wherein the first signal and the second signal are electromagnetic wave of infrared range.

10. The coordinate detection apparatus of claim 6, wherein the first signal and the second signal are electromagnetic wave of infrared range having the same wavelength.

11. A coordinate detection method for detecting coordinates pointed by a pointing operation of a pointing device on a board face, comprising the steps of:
outputting a first signal along a board face of the image display (first signal outputting step);
receiving the first signal output by the first signal transmitting step (first signal receiving step);
detecting coordinates pointed by the pointing device based on the first signal received at the first signal receiving step (first coordinate detecting step);
transmitting a third signal to the pointing device to request an output of a second signal from the pointing device when the first coordinates detecting step does not detect coordinates pointed by the pointing device based on the received first signal (request transmitting step);
receiving the second signal output from the pointing device (second signal receiving step); and
detecting coordinates pointed by the pointing device based on the second signal received by the second signal receiving step (second coordinates detecting step).

12. The method of claim 11, wherein the request transmitting step transmits a fourth signal to the pointing device to request the pointing device to stop an output of the second signal when coordinates pointed by the pointing device is detected at the first coordinate detecting step.

13. The method of claim 11, wherein the pointing device includes a pressure detector that detects pressure applied to the image display,
wherein the request transmitting step transmits a fourth signal to the pointing device to request the pointing device to stop an output of the second signal when the pressure detector does not detect pressure.

14. The method of claim 11, wherein the first signal and the second signal are electromagnetic wave of infrared range.

15. The method of claim 11, wherein the first signal and the second signal are electromagnetic wave of infrared range having the same wavelength.
